(19) United States
(12) Patent Application Publication
(10) Pub. No.: US 2010/0058972 A1
(43) Pub. Date: Mar. 11, 2010

(54) Mini flag clip

(76) Inventor: Mensan Teko Kinvi, New York, NY (US)

Correspondence Address: Mensan Kinvi, 2nd Floor, 1311 Boynton Avenue, New York, NY, 10472, US

(21) Appl. No.: 12/462,479

(22) Filed: Aug. 4, 2009

Related U.S. Application Data
(60) Provisional application No. 61/191,256, filed on Sep. 8, 2008.

(51) Int. Cl. G09F 17/00

(52) U.S. Cl. 116/173

(57) ABSTRACT

A device to connect common headgears to common mini flags or banners. Functioning as a clip and a womb as well, it applies a strong enough hold on headgears and provides a cavity for common mini flags' standards to stand straight to let the flag float above the head of the bearer.

### CROSS-REFERENCE TO RELATED APPLICATION

The present application claims the priority of U.S. provisional application No. 61/191,256 filed on Sep. 8, 2008, by inventor Mensan T Kinvi.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### THE NAMES OF THE PARTIES TO A JOINT RESEARCH AGREEMENT

Not applicable

### BACKGROUND OF THE INVENTION

1. Field of the Invention

The present invention relates to devices and methods concerning flags' and banners' bearing on headgears.

2. Description of the Related Art

Social life anywhere is punctuated by frequent special moments like parades, rallies, games, and concerts. During these special moments, flags and banners are the best useful objects people display to show off sympathy or fun. But flag holding during parades and other manifestations is not an easy job. Most of the flags or banners are chosen at a size that only strong arms can hold them for a bit long time. Weak arms that choose small size flags and banners are not at comfort either. Holding and shaking even a mini flag or banner doesn't give you room to sip freely your coffee to rocket your enthusiasm or to lick an ice-cream to cool off during these exiting moments. So what could be a solution? What can make it easy to happy people in crowd or enthusiastic groups to display floating flags and banners in unison?

The Mini Flag Clip is invented as the solution.

U.S. Pat. Nos. 3,104,644—3,106,184—3,213,823—2,345,051—4,905,406—5,903,925—6,616,294—1,036,168—2,167,579—6,874,167—5,881,391—5,530,970 are part of the prior art of the herein invention and illustrate devices for bearing flags on headgears of different kinds.

While the above patents cited in statement 0004 are efficacious to achieve their goal, there is a necessity for researches to advance the art and the methods.

Close examination shows that none of the devices cited above in statement 0004 is designed to serve as a connector between common mini flags, banners and a various range of common headgears lining from baseball caps, visor caps, do-rags to headbands. Their methods are obviously different, limited and more complex compared to the invention herein.

### BRIEF SUMMARY OF THE INVENTION

The Mini Flag Clip, designed with a very simple feature, is a different technique and the easiest method to fix common mini flags and banners to various common headgears.

This one-piece device intends to be a connector between already existing headgears and already existing and popular mini flags or banners. The Mini Flag Clip permits to take the lovely Mini Flag from the tables and the shelves in the office, in the house to the heads of the people on the streets and everywhere else manifestations happen. Any common headgear like baseball caps, visor caps, do-rags and headbands can get it fixed on easily. Once the mini flag clip is fixed on a headgear, a mini flag or banner can be easily inserted into it, and hold straight. The bearer can then go hands free to show off pride or support with a flag or a banner floating on his head.

### BRIEF DESCRIPTION OF SEVERAL VIEWS OF THE DRAWING

FIG. 1: The Mini Flag Clip in perspective view laying flat, face up, seen from above on one corner.

FIG. 2: The Mini Flag Clip in standing position seen from front.

FIG. 3: The Mini Flag Clip in standing position seen from back,

FIG. 4: The Mini Flag Clip attached to a common visor cap.

FIG. 5: The Mini Flag Clip attached to a common baseball cap and a common mini flag inserted into the Mini Flag Clip.

### DETAILED DESCRIPTION OF THE INVENTION

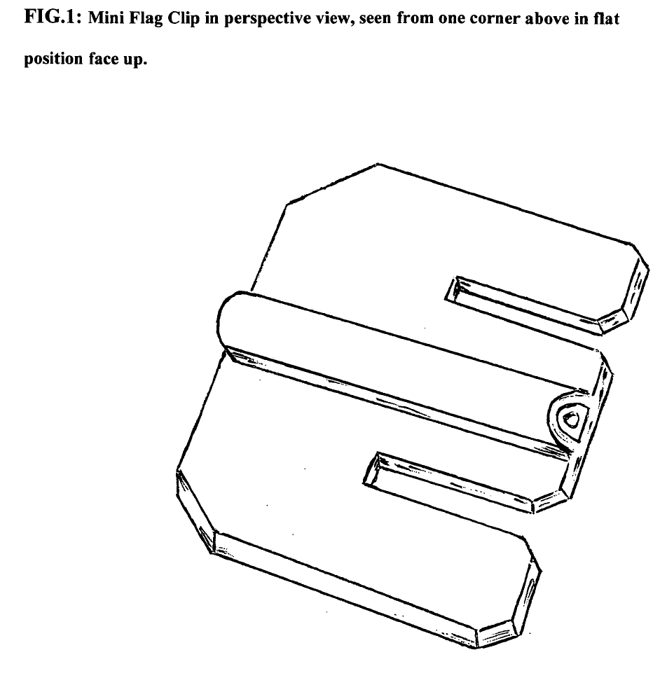

FIG. 1: The Mini Flag Clip is a manufactured utility in solid material. The best material would be hard and rigid plastic or hard and rigid metal. The device is a flat squared plaque measuring ideally 5 cm by 4 cm. The edge is 2 mm thick. These measurements can be a little less or more and the device will still function.

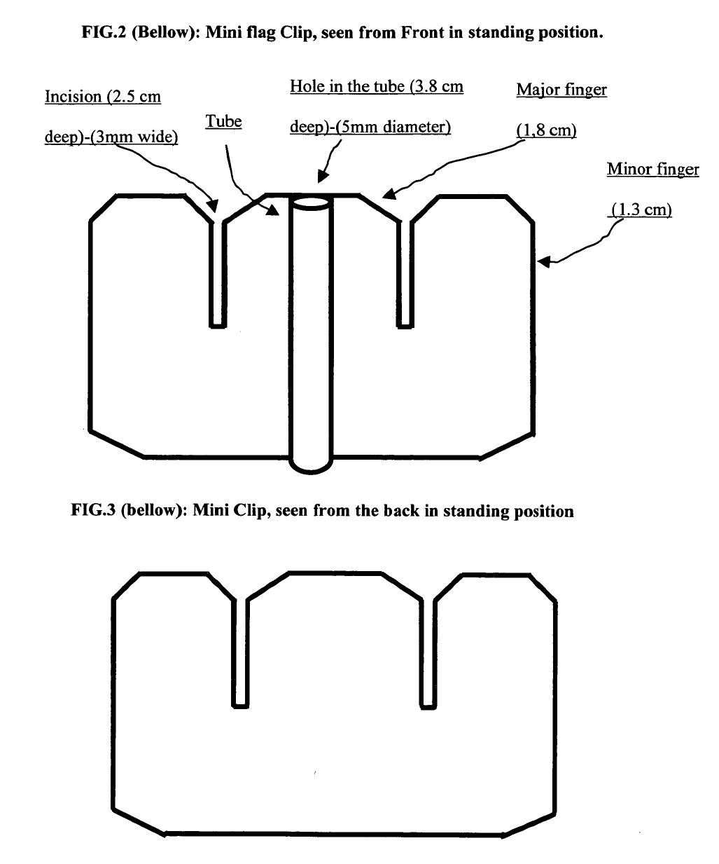

A tube is firmly attached by all its length on one surface of the plaque right in the middle, shown in annotations of FIG. 2. The tube is parallel to the width edges of the square plaque and closed at one end. That end is the base. The hole in the tube is circular with 5 mm of diameter and is 3.8 cm deep.

Two incisions, parallel and symmetric to the tube, cut the plaque starting from the length side where the tube is open, shown in FIG. 2. The symmetric incisions are ½ cm away from the tube and 1.3 cm away from the width edges of the plaque. The incisions are identical in size: 3 mm in width and 2.5 cm in length.

The two incisions sculpt the plaque in the shape of a “three fingered hand”: a major finger at the middle, where the tube is attached, and two minor fingers at each side, shown in FIG. 2. The major finger is 1.8 cm large, the two minor fingers are identical and measure 1.3 cm each in width.

The entrance to the incisions is cut slanting. All the four corners of the plaque are also slightly cut slant, shown in FIG. 2. The backside of the Mini Flag Clip is totally flat as seen in FIG. 3.

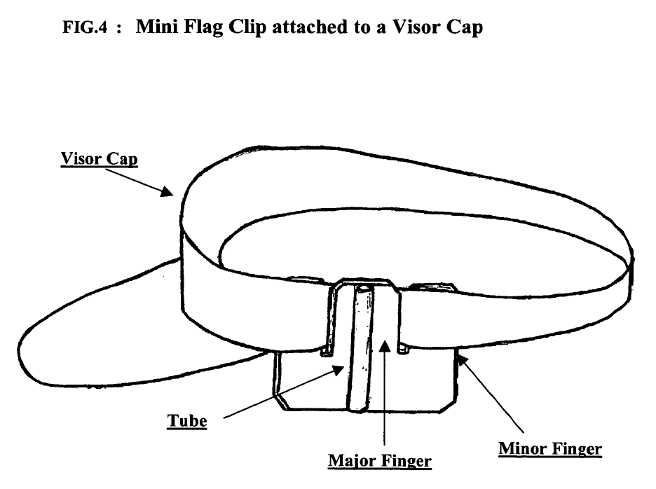

As specified in size, measurements and material at statements 0014 to 0017, the Mini Flag Clip is a ready to plug and use device. To use it, one just needs a regular headgear like a baseball cap, a visor cap, a military hat, a bandana or a do-rag and a common mini Flag. Before wearing the headgear one just proceeds to pass the head covering edge of the garment through the ‘fingers’ of the Mini Flag Clip by the incisions. FIG. 4 illustrates the outcome of the procedure showing a common visor cap with the Mini Flag Clip inserted on it. A do-rag, a bandana, a headband or baseball cap will use the same procedure.

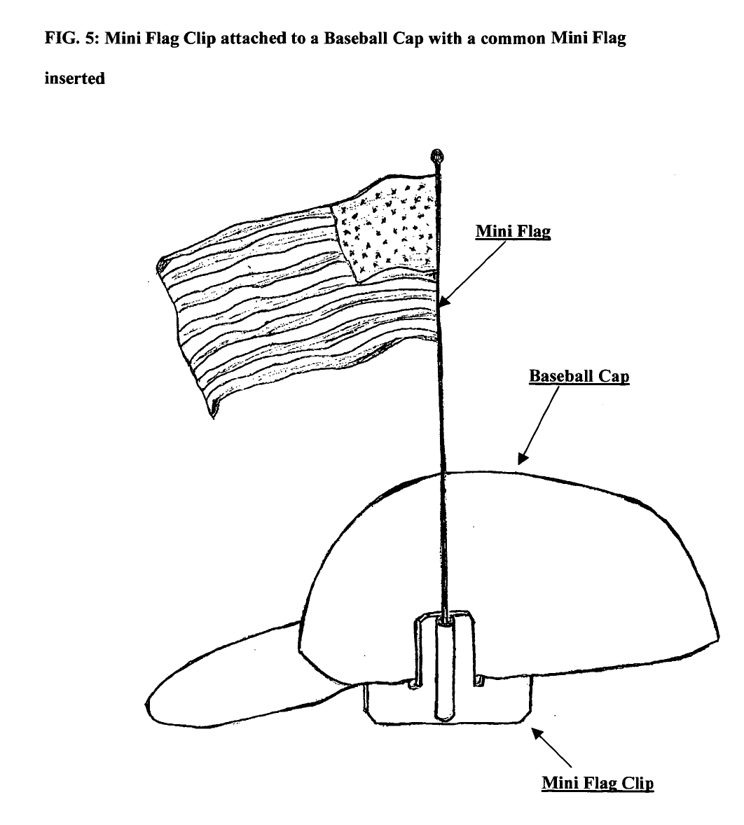

When inserting the clip on the headgear, the tube and the major finger are left outside of the garment and the minor fingers go inside. The clip grips the garment and stays fixed. The mini flag's standard is then inserted in the tube. It stays straight up, shown in FIG. 5.

As seen in FIG. 4 and FIG. 5, and described in statement 0020, the ‘fingers’ on the device are intended to apply a strong enough hold on the edge of any ordinary headgear; and the tube is to host the standard of usual mini flags or banners. The hole in the tube is large enough to insert and remove easily a common mini flag's standard.

1- A device to connect common mini flags and banners to common headgear like baseball caps, visor caps, headbands, do-rags and bandanas.

2- The device in claim 1 is made of hard and rigid material such as plastic or metal and is a one-piece apparatus structured in a manner that it can secure a firm grip on any common headgear mentioned in claim 1.

3- The said structure in claim 2 comprises of a flat square plaque partially cut into three rods, by two incisions, and herein called fingers which are designed to apply a grip on common headgears.

4- One of the fingers mentioned in claim 2, the centerpiece, has a tube sealed on it longitudinally as a means to hold the standard of common mini flags or banners straight up on any common headgear like baseball caps, visor caps, do-rags, bandanas and headbands.

5- The device in claim 1 introduce a rupture of method in the art of flag bearing on headgears and provides the easiest manner up-to-date to bear common mini flags and banners in any place at any occasion for fun or to show off attachment to a cause.

6- While the invention in claim 1 is described according to specific drawings herein, many changes and modifications for improvement of the invention can become apparent and it is being understood that only the preferred characteristics have been considered and are not restrictive, thus any change and modification that emerge within the spirit of the invention are desired to be protected.

7- Based on the statement set forth in claim 6, different kinds of gadgets with standards, like fancy glowing devices, can become more enjoyable when displayed on headgears using the Mini Flag Clip, the utility of this invention is desired to be extended to such procedures.
